(19) United States
(12) Patent Application Publication
(10) Pub. No.: US 2009/0067177 A1
(43) Pub. Date: Mar. 12, 2009

(54) Manufacturing Method of Optical Film with Focusing Function and Backlight Module using the Optical Film

(76) Inventor: SHIN- PING KUNG, Jiangsu (CN)

Correspondence Address: HDLS Patent & Trademark Services, P.O. BOX 220746, CHANTILLY, VA, 20153-0746, US

(21) Appl. No.: 12/060,308

(22) Filed: Apr. 1, 2008

(30) Foreign Application Priority Data
Sep. 7, 2007 (TW) 096133468

(51) Int. Cl. F21V 13/04; B05D 5/06

(52) U.S. Cl. 362/309; 427/596

(57) ABSTRACT

An optical film with focusing function is applicable to a backlight module for adjusting an optical property thereof. A manufacturing method of the optical film includes the steps of: (a) providing a transparent base including a light incident surface and a light output surface, the light output surface having a plurality of focusing microstructures formed thereon; (b) forming a reflective layer on the light incident surface; and (c) providing a laser beam incident on the reflective layer from at least one of the focusing microstructures, the laser beam being focused on the reflective layer by the at least one of the focusing microstructures and forming at least one aperture in the reflective layer, the at least one aperture being corresponding to the at least one of the focusing microstructures. A backlight module using the manufactured optical film is also described.

### BACKGROUND

1. Technical Field

The present invention generally relates to an optical film and, particularly, to an optical film with focusing function and a backlight module using the optical film.

2. Description of the Related Art

Nowadays, liquid crystal displays (LCDs) are widely used in various information technology, communication and consuming electronic products, such as personal computers, LCD televisions, mobile phones, videophones, personal digital assistants, and so on. Because a LCD panel is nonluminous, a backlight module is necessarily required for images display. The backlight modules are rather suitably equipped with various different optical films to improve their optical properties, so as to meet the requirements for different LCD panels. For example, an optical film with focusing function can be used for the adjustments of the optical properties, such as central brightness and half view angle, of the backlight module that is equipped with the optical film.

Referring to FIG. 1, a conventional optical film 80 with focusing function is shown. The optical film 80 includes a transparent base 82 and a reflective coating layer 84 formed on a light incident surface of the transparent base 82. A light output surface of the transparent base 82 has a plurality of lenticular lenses 822 formed thereon. The light incident surface has a plurality of convex microstructures 824 spaced in intervals and formed thereon. The reflective coating layer 84 has a plurality of apertures 842 formed therein, and each of the apertures 842 is located between two adjacent convex microstructures 824. Generally speaking, The apertures 842 are necessarily to be accurately formed in positions corresponding to the focusing parts of the respective lenticular lenses on the light incident surface, otherwise the light output and refractive angles of the optical film 80 would be seriously influenced so that the desired optical performance would not be obtained. However, in the manufacturing process of the optical film 80, it is necessary to accurately align the microstructures on the light incident surface and the light output surface (i.e., the lenticular lenses and the convex microstructures) by mechanical means and thereafter coating a reflective material on the convex microstructures 824 by printing to form the reflective coating layer 84. In one aspect, the manufacturing process is complex, which results in the yield thereof cannot be easily increased. In another aspect, due to the influence of the mechanical accumulated tolerance, the alignment accuracy of the mechanical means are limited and therefore sizes of the microstructures generally are larger than 150 micrometers; as a result, the optical performance of the optical film 80 is difficult to be further improved.

### BRIEF SUMMARY

One object of the present invention is to provide a manufacturing method for an optical film with focusing function, which is simple and the manufactured optical film can obtain a better optical performance.

Another object of the present invention is to provide a backlight module having an optical film with focusing function, which can obtain a better optical performance. The other objects and advantages of the present invention can be further known from technologic properties disclosed by the present invention.

In order to achieve one of or some of or all of the above-mentioned objects or other objects, a manufacturing method for an optical film with focusing function, in accordance with a present embodiment, is provided. The optical film is applicable to a backlight module for adjusting the optical property of the backlight module. The manufacturing method includes the steps of: (a) providing a transparent base, the transparent base including a light incident surface and a light output surface opposite to the light incident surface, the light output surface having a plurality of focusing microstructures formed thereon; (b) forming a reflective layer on the light incident surface of the transparent base; (c) providing a laser beam incident on the reflective layer from at least one of the focusing microstructures, which being focused on the reflective layer by at least one of the focusing microstructures and forming at least one aperture corresponding to the at least one of the focusing microstructures in the reflective layer

A backlight module, in accordance with another present embodiment, is provided. The backlight module includes an optical film and a plane light source. The optical film includes a transparent base, a reflective layer, and a plurality of focusing microstructures arranged in an array. The transparent base has a light incident surface and a light output surface opposite to the light incident surface, and the light output surface has the plurality of focusing microstructures formed thereon. The reflective layer is formed on the light incident surface. The reflective layer includes a plurality of apertures formed therein by laser ablation. Positions and sizes of the apertures are corresponding to that of the focusing microstructures. The plane light source device is disposed at a side of the optical film which is adjacent to the reflective layer.

The formation of the apertures in the reflective layer makes use of a laser ablation process, so that the positions of the apertures may be accurately aligned with that of the corresponding focusing microstructures by virtue of the light path the laser light pass therethrough in the focusing microstructures formed on the corresponding light output surfaces. As a result, the finally manufactured optical film can obtain a better optical property. In addition, it is unnecessary to form convex microstructures on the light incident surface associated with the related art, before forming the reflective layer, which renders simplifying the manufacturing process.

Other objectives, features and advantages of the present invention will be further understood from the further technological features disclosed by the embodiments of the present invention wherein there are shown and described preferred embodiments of this invention, simply by way of illustration of modes best suited to carry out the invention

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, front view of an optical film with focusing function, in accordance with the related art.

FIG. 2 is a schematic, perspective view of a transparent base, in accordance with a first embodiment of the present invention.

FIG. 3 is a schematic, front view of the transparent base of FIG. 2 after being formed a reflective layer on a light incident surface thereof.

FIG. 4 is a schematic, front view of the reflective layer of FIG. 3 being formed an aperture therein by laser ablation.

FIG. 5 is a schematic, front view of the finally manufactured optical film with focusing function, in accordance with the first embodiment of the present invention.

FIG. 6 is a schematic, bottom view of the reflective layer of the optical film of FIG. 5.

FIG. 7 is a schematic, perspective view of a transparent base, in accordance with a second embodiment of the present invention.

FIG. 8 is a schematic, sectional view of the transparent base of FIG. 7 after being formed a reflective layer on a light incident surface thereof, taken along the line III-III in FIG. 7.

FIG. 9 is a schematic, sectional view of the reflective layer of FIG. 8 being formed an aperture therein by laser ablation.

FIG. 10 is a schematic, sectional view of the finally manufactured optical film with focusing function, in accordance with the second embodiment of the present invention.

FIG. 11 is a schematic, bottom view of the reflective layer of the optical film of FIG. 10.

FIG. 12 is a schematic view of a backlight module, in accordance with a third embodiment of the present invention.

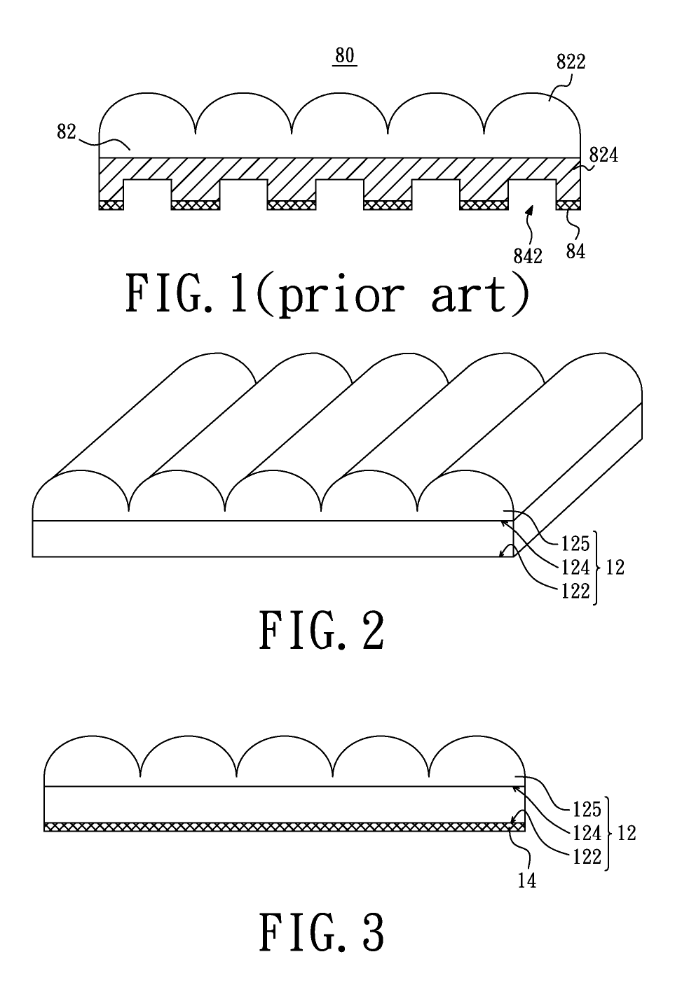

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

Referring to FIG. 2 through FIG. 6, a manufacturing method for an optical film 10 with focusing function, in accordance with a first embodiment, is provided. The manufacturing method may include the steps as described below.

Referring to FIG. 2, a transparent base 12 is provided. The transparent base 12 includes a light incident surface 122, a light output surface 124 opposite to the light incident surface 122, and a plurality of focusing microstructures arranged in an array. The light incident surface 122 may be a flat surface. The focusing microstructures e.g., the lenticular lenses 125 arranged in an array as illustrated in the present embodiment, are formed on the light output surface 124. The lenticular lenses 125 can be formed by way of ultra-violent embossing, mechanical machining or etching, and so on. The transparent base 12, rather suitably, is made of a polymer material with high transparency, such as polyethylene terephthalate (PET), polycarbonate (PC), polyvinyl chloride (PVC), and so on. As illustrated in FIG. 2, the transparent base 12 is a bi-layer structure. The lenticular lenses 125 arranged in array are made of material different from that of the portion between the light incident surface 122 and the light output surface 124.

Referring to FIG. 3, a reflective layer 14 is formed on the light incident surface 122 of the transparent base 12. The reflective layer 14 can be formed by way of coating a reflective material on the light incident surface 122. The reflective material may absorb invisible laser light while reflect the visible light. As illustrated in FIG. 3, the reflective layer 14 is a single layer structure.

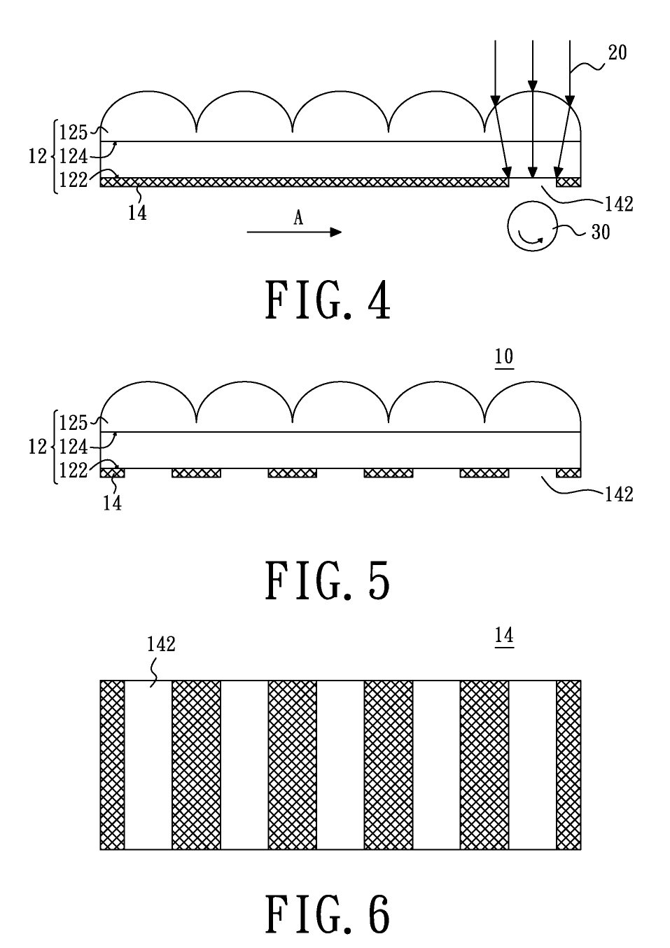

Referring to FIG. 4 through FIG. 6, a laser beam 20 is provided to incident on the reflective layer 14 from one of the lenticular lenses 125 formed on the light output surface 124. The laser beam 20 is focused on the reflective layer 14 by the lenticular lens 125. A region of the reflective layer 14 where the laser beam 20 focused absorbs the high energy and thus is ablated, and thereafter an aperture 142 can be formed in the reflective layer 14. By moving the transparent base 12 and the reflective layer 14 together along the “A” direction of FIG. 4 so as to make the laser beam 20 sequentially pass through the lenticular lenses 125 formed on the light output surface 124 to, a plurality of apertures 142 (as shown in FIGS. 5 and 6) can be formed in the reflective layer 140. As a result, an optical film with focusing function can be manufactured. The apertures 142 of the optical film 10 are respectively aligned with the focusing parts of the respective lenticular lenses on the light incident surface 122, so that the positions and sizes of the apertures 142 are corresponding to that of the lenticular lenses 125. It is understood that by using multiple laser beams 20 or keeping the transparent base 12 and the reflective layer 14 fixed while moving the laser beam with respect to the transparent base 12 and the reflective layer 14, it also can form a plurality of apertures 142 in the reflective layer 14. The laser beam 20 rather suitably is an ultra-violent laser beam, a carbon dioxide (CO2) laser beam, or an Nd-YAG laser beam, and so on, in invisible light range. It is understood that the laser beam 20 ought to have a wavelength matched with an absorption wavelength of the reflective layer 14. The laser beam 20 beneficially is a linear beam extending along a direction substantially perpendicular to the “A” direction of FIG. 4 or a plurality of point-like beams arranged along the direction substantially perpendicular to the “A” direction.

Preferably, in order to speed up the formation of the apertures 142, a cleaning device such as a sticking wheel or a vacuum suction device, is beneficially disposed below the reflective layer 14, so as to remove the residual waste produced in the laser ablating process.

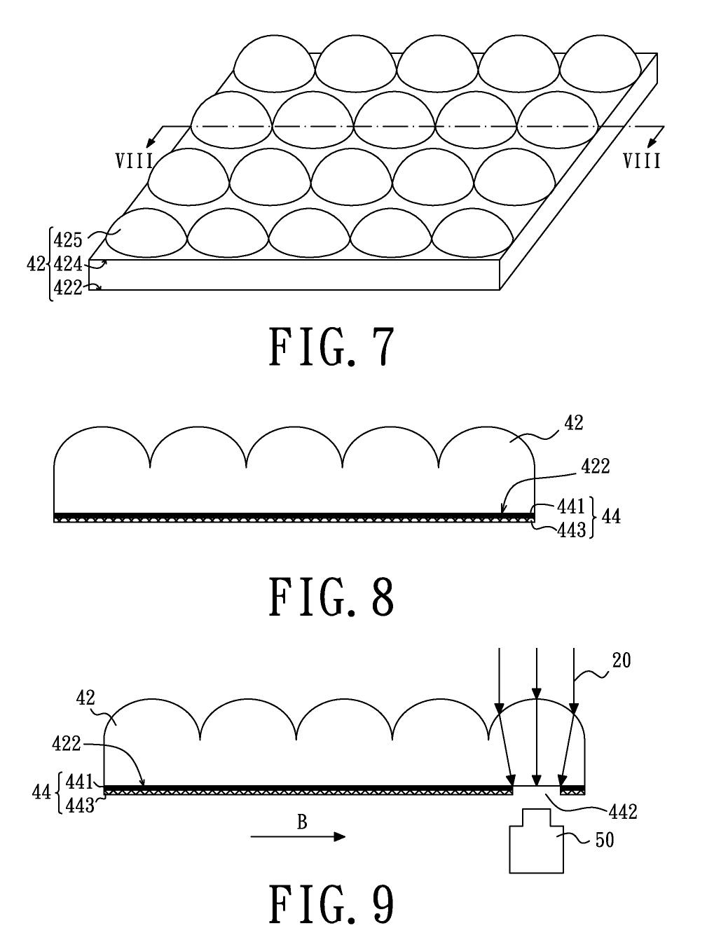

Referring to FIG. 7 through FIG. 11, a manufacturing method for an optical film with focusing function, in accordance with a second embodiment, is provided. The manufacturing method may include the steps as described below.

As shown in FIG. 7, a transparent base 42 is provided. The transparent base 42 includes a light incident surface 422, a light output surface 424 opposite to the light incident surface 422, and a plurality of focusing microstructures arranged in an array. The light incident surface 422 may be a flat surface. The focusing microstructures, e.g., a plurality of micro-lenses 425 arranged in an array as illustrated in FIG. 7, are formed on the light output surface 424. The micro-lenses 425 can be formed by way of ultra-violent embossing, mechanical machining, or etching, and so on. The transparent base 42 rather suitably is made of polyethylene terephthalate, polycarbonate, polyvinyl chloride, or other polymer materials with high transparency. As illustrated in FIG. 7, the transparent base 42 is a single layer structure, and thus the micro-lenses 425 are made of a material same as that of the portion between the light output surface 424 and the light incident surface 422. Therefore, the transparent base 42 and the micro-lenses 425 can be integrally formed.

As shown in FIG. 8, a reflective layer 44 is formed on the light incident surface 422 of the transparent base 42. In particular, the reflective layer 44 includes a first coating layer 441 and a second coating layer 443. The first coating layer 441 is sandwiched between the light incident surface 422 and the second coating layer 443. The first coating layer 441 beneficially is a dark material, such as a black material, which has a better absorption of an invisible laser beam capability. The second coating layer 443 is a visible reflective coating for reflecting visible light. The first coating layer 441 and the second coating layer 443 both can be formed by way of coating. The employment of the first coating layer 441 can improve the absorption of an invisible laser beam capability of the reflective layer 44, so as to accelerate an ablation rate in the subsequent process.

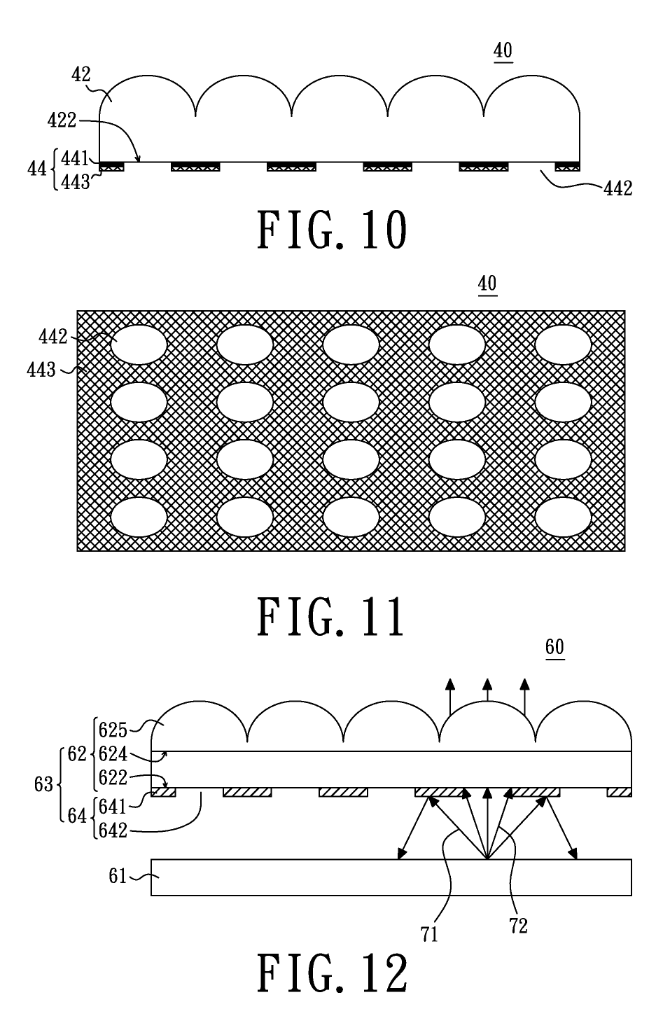

As shown in FIG. 9 through FIG. 11, a laser beam 20 is provided to be incident on the reflective layer 44 from one of the micro-lenses 425 formed on the light output surface 424. The laser beam 20 is focused on the reflective layer 44 by the micro-lenses 425. A region of the reflective layer 44 where the laser beam 20 focused absorbs the high energy and thus is ablated, and therefore an aperture 442 can be formed in the reflective layer 44. By moving the transparent base 42 and the reflective layer 44 together along the “B” direction of FIG. 9 so as to make the laser beam 20 sequentially pass through the micro-lenses 425 formed on the light output surface 424, a plurality of apertures 442 (as shown in FIGS. 10 and 11) can be formed in the reflective layer 44. As a result, an optical film 40 with focusing function can be finally manufactured. The apertures 442 of the optical film 40 respectively are aligned with the focusing parts of the respective micro-lenses 425 on the light incident surface 422, and penetrate through the first and the second coating layers 441, 443. Therefore, positions and sizes of the apertures 442 are corresponding to that of the micro-lenses 425. It is understood that by using multiple laser beams 20 or keeping the transparent base 42 and the reflective layer 44 fixed while allowing the laser beam 20 to be moved with respect to the transparent base 42 and the reflective layer 44, a plurality of apertures 442 also can be formed in the reflective layer 44. The laser beam 20 rather suitably is an ultra-violent laser beam, a carbon dioxide laser beam, or a Nd:YAG laser beam, and so on, in invisible light range. It is understood that the laser beam 20 ought to have a wavelength matched with an absorption wavelength of the first coating layer 441 of the reflective layer 44. The laser beam 20 may be a plurality of point-like beams arranged along a direction substantially perpendicular to the “B” direction of FIG. 9.

Similar to that of the above-mentioned first embodiment, in order to speed up the formation of the apertures 442, a cleaning device 50, such as sticking wheel or a vacuum suction device is rather suitably disposed below the second coating layer 443 of the reflective layer 44, so as to remove the residual waste produced in the laser ablation process. Preferably, the cleaning device 50 is synchronously moved with the laser beam 20, so that the produced residual waste can be immediately removed during the process of ablating a plurality of apertures 442 in the reflective layer 44 step by step.

In addition, it is understood by the skilled person in the art that the structures of the transparent bases 12, 42 or the structures of the reflective layers 14, 44 in the first and the second embodiments, are replaceable with each other, and the purpose of an embodiment of the present invention still can be achieved.

In the manufacturing methods of optical films 10, 40 with focusing function according to the first and the second embodiments, due to the utilization of a laser ablation process for forming a plurality of apertures 142, 442 in the corresponding reflective layers 14, 44 formed on the light incident surfaces 124, 424 of the transparent bases 12, 42, the positions of the apertures 142, 442 can be accurately aligned with that of the corresponding focusing microstructures by virtue of the light path the laser light pass therethrough in the focusing microstructures formed on the corresponding light output surfaces 124, 424. As a result, the manufactured optical films 10, 40 each can be endowed with a better optical property. In addition, because it is unnecessary to form convex microstructures on the light incident surfaces 122, 422 of the transparent bases 12, 42 before the formation of the reflective layer, the manufacturing process can be simplified. Furthermore, by simplifying the double-face molding process associated with the related art to be a single-face molding process, the defective rate resulting from an error of the mechanical alignment can be reduced and the productivity can be improved as a result.

Referring to FIG. 12, a backlight module 60 having an optical film with focusing function, in accordance with a third embodiment, is provided. The backlight module 60 is applicable to a liquid crystal display for the provision of an illumination light. The backlight module 60 includes a plane light source device 61 and an optical film 63.

The optical film 63 includes a transparent base 62 and a reflective layer 64. The transparent base 63 includes a light incident surface 622, a light output surface 624 opposite to the light incident surface 622, and a plurality of focusing microstructures 625 arranged in an array and formed on the light output surface 624. The focusing microstructures 625 each can be a lenticular lens or a micro-lens. The light incident surface 622 may be a flat surface. The reflective layer 64 is formed on the light incident surface 622 of the transparent base 62. The reflective layer 64 includes a plurality of apertures 642 and a plurality of reflecting portions 641 each located between two adjacent apertures 642. The reflective layer 64 may be a single layer structure, and also may be a multi-layer structure such as a bi-layer structure. The optical film 63 may be one of the manufactured optical films 10 and 40, provided in the first and the second embodiments.

The plane light source device 61 is disposed at a side of the optical film 63 which is adjacent to the reflective layer 64 thereof, for the provision of a surface light. The plane light source device 61 may be the one used in an edge-type backlight module or a direct-type backlight module, and includes a point or a linear light source, or other well-known suitable plane light source devices.

When the backlight module 60 is in operation, the plane light source device 61 emits light rays to illuminate the optical film 63, a part of light rays 71 is reflected back by the reflecting portions 641 and thus could not directly enter the light incident surface 622 of the transparent base 62. The part of the light rays 71 is reflected and recycled by the plane light source device 61. The other part of light rays 72 will enter the light incident surface 622 of the optical film 60 through the apertures 642 and then emerge from the optical film 60 after being focused by the focusing microstructures 625 formed on the light output surface 624. Due to the reflection function of the reflecting portions 641 of the reflective layer 64 and the accurate alignment of the apertures 642 with the focusing parts of the respective focusing microstructures 625 on the light incident surface 622, the light rays 72 entered the transparent base 62 through the apertures 642 can be easily focused and collected by the focusing microstructures 625. As a result, a central brightness and a half view angle of the backlight module 60 can be effectively adjusted and a better optical performance correspondingly can be obtained.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A manufacturing method of an optical film with focusing function, the optical film being applicable to a backlight module for adjusting the optical property of the backlight module, the manufacturing method comprising the steps of:
providing a transparent base comprising a light incident surface and a light output surface opposite to the light incident surface, the light output surface having a plurality of focusing microstructures formed thereon;
forming a reflective layer on the light incident surface; and
providing a laser beam incident on the reflective layer from at least one of the focusing microstructures, the laser beam being focused on the reflective layer by the at least one of the focusing microstructures and forming at least one aperture in the reflective layer, the at least one aperture being corresponding to the at least one of the focusing microstructures.

2. The manufacturing method according to claim 1, wherein the focusing microstructures formed on the light output surface are arranged in an array, the forming step of the at least one aperture comprising the step of enabling a relative movement between the focusing microstructures, the transparent base and the reflective layer together and the laser beam, so as to make the laser beam sequentially pass through the focusing microstructures.

3. The manufacturing method according to claim 2, further comprising the step of removing a residual waste produced by the laser beam ablating the reflective layer.

4. The manufacturing method according to claim 3, wherein the removing step and the ablating step of the at least one aperture are synchronous.

5. The manufacturing method according to claim 3, wherein the removing step is implemented by disposing a cleaning device at a side of the reflective layer which is away from the transparent base.

6. The manufacturing method according to claim 5, wherein the cleaning device is a sticking wheel or a vacuum suction device.

7. The manufacturing method according to claim 2, wherein the laser beam is a linear beam extending along or a plurality of point-like beams arranged along a direction substantially perpendicular to the direction of the relative movement.

8. The manufacturing method according to claim 7, wherein each of the focusing microstructures is one of a lenticular lens or a micro-lens.

9. The manufacturing method according to claim 2, wherein the laser beam is an invisible laser beam and a wavelength thereof is matched with an absorption wavelength of the reflective layer.

10. The manufacturing method according to claim 9, wherein the laser beam is an ultra-violent laser beam, an carbon dioxide laser beam or a Nd:YAG laser beam.

11. The manufacturing method according to claim 1, wherein the transparent base and the focusing microstructures arranged in array are integrally formed.

12. The manufacturing method according to claim 1, wherein the reflective layer reflects the visible light while absorbs an invisible laser beam.

13. The manufacturing method according to claim 1, wherein the reflective layer comprises a first coating layer for absorbing the laser beam and a second coating layer for reflecting the visible light, the first coating layer is sandwiched between the light incident surface and the second coating layer, and the at least one aperture penetrates through the first and the second coating layers.

14. The manufacturing method according to claim 1, wherein the light incident surface is a flat surface.

15. A backlight module, comprising:
an optical film comprising a transparent base, a reflective layer, and a plurality of focusing microstructures arranged in an array, the transparent base having a light incident surface and a light output surface opposite to the light incident surface, the light output surface having the focusing microstructures formed thereon, and the reflective layer comprising a plurality of apertures formed by laser ablation, positions and sizes of the apertures being corresponding to that of the focusing microstructures; and
a plane light source device disposed at a side of the optical film which is adjacent to the reflective layer.

16. The backlight module according to claim 15, wherein the reflective layer reflects the visible light while absorbs an invisible laser beam.

17. The backlight module according to claim 15, wherein the reflective layer comprises a first coating layer for absorbing the laser beam and a second coating layer for reflecting the visible light, the first coating layer is sandwiched between the light incident surface and the second coating layer, and the apertures penetrate through the first and the second coating layers.

18. The backlight module according to claim 15, wherein the transparent base and the focusing microstructures are integrally formed.

19. The backlight module according to claim 15, wherein each of the focusing microstructures is one of a lenticular lens or a micro-lens.

20. The backlight module according to claim 15, wherein the light incident surface is a flat surface.
